(19) United States
(12) Patent Application Publication
(10) Pub. No.: US 2025/0291872 A1
(43) Pub. Date: Sep. 18, 2025

(54) ANALYSIS DEVICE, ANALYSIS METHOD, AND RECORDING MEDIUM

(71) Applicant: Kioxia Corporation, Tokyo (JP)

(72) Inventor: Hirotaka TSUDA, Yokkaichi (JP)

(73) Assignee: Kioxia Corporation, Tokyo (JP)

(21) Appl. No.: 18/974,234

(22) Filed: Dec. 9, 2024

(30) Foreign Application Priority Data
Mar. 18, 2024 (JP) 2024-041972

(51) Int. Cl. G06F 17/11

(52) U.S. Cl. CPC G06F 17/11

(57) ABSTRACT

According to one embodiment, an analysis device includes a processor. The processor calculates a first contribution degree, which is a contribution degree of a first explanatory variable for a first set, based on a training data set used for generating a prediction model. The prediction model receives explanatory variables and outputs a predicted value corresponding to the explanatory variables. The first set is a set of values of the explanatory variables. The first explanatory variable is one of the explanatory variables. The processor calculates, based on the training data set, a second contribution degree of the first explanatory variable for a second set that is a set of values of the explanatory variables and is different from the first set. The processor obtains a third contribution degree by calculating a difference between the first contribution degree and the second contribution degree and outputs the third contribution degree.

### CROSS-REFERENCE TO RELATED APPLICATIONS

This application is based upon and claims the benefit of priority from Japanese Patent Application No. 2024-041972, filed on Mar. 18, 2024, the entire contents of which are incorporated herein by reference.

### FIELD

Embodiments described herein relate generally to an analysis device, an analysis method, and a recording medium.

### BACKGROUND

In recent years, machine learning has spread to various fields and has been applied to predict complex phenomena, optimize conditions, and so on. From a practical standpoint, there is an increasing need for explanation and interpretation of the predicted values obtained by machine learning models.

One of the “explainable AI techniques (explainable AI (XAI))” of machine learning is SHapley Additive explanations (SHAP). According to SHAP, the SHAP value, which is numerical information representing the contribution degree to the predicted value, can be obtained for each explanatory variable. The contribution degree is also referred to as an importance degree, a priority level, or the like.

### BRIEF DESCRIPTION OF THE DRAWINGS

FIG. 1 is a schematic diagram illustrating the algorithm for calculating the contribution degree of each individual condition according to the embodiment;

FIG. 2 is a schematic diagram illustrating an example of the hardware configuration of the analysis device according to the embodiment;

FIG. 3 is a flowchart illustrating an example of the operation of the analysis device according to the embodiment;

FIG. 4 illustrates an example of a pair of the process condition and the predicted value obtained by processing in S102 to S105 illustrated in FIG. 3;

FIG. 5 illustrates the reference value determined by the training data set according to the embodiment; and

FIG. 6 illustrates an example of how the SHAP value of each individual condition is displayed according to the embodiment.

### DETAILED DESCRIPTION

According to the embodiment, an analysis device includes a processor. The processor is configured to calculate a first contribution degree being a contribution degree of a first explanatory variable out of multiple explanatory variables for a first set being a set of values of the multiple explanatory variables. The first contribution degree is calculated based on a training data set used for generating a prediction model to which the multiple explanatory variables are input and from which a predicted value corresponding to the multiple explanatory variables is output. The processor is configured to calculate, based on the training data set, a second contribution degree being a contribution degree of the first explanatory variable for a second set. The second set is different from the first set and is a set of values of the multiple explanatory variables. The processor is configured to obtain a third contribution degree by calculating a difference between the first contribution degree and the second contribution degree. The processor is configured to output the third contribution degree.

Machine learning can also be applied in the development of processes for manufacturing semiconductor devices (henceforth, process development). For example, when a machine learning model configured to receive a process condition as a group of explanatory variables and output the process result as a predicted value is generated, it is possible to optimize the process condition by using the machine learning model.

The process condition is a condition under which the semiconductor device is manufactured, and is a variable condition that can be set by the engineer. The process condition can include a plurality of conditions. Each of the conditions included in the process condition is denoted as an individual condition. When the process condition is input into a machine learning model, each individual condition is an explanatory variable that constitutes a group of explanatory variables.

In process development, especially in its early stages, there is a need to understand the effect of improvement from the current process of record (POR) conditions. For example, an engineer may want to identify, for each individual condition, the degree to which a change in predicted value is brought, namely, the contribution degree to the change in predicted value, when the predicted value is changed by changing the process condition to be input to the prediction model from the POR condition to another condition.

When SHAP is applied, it is possible to obtain the SHAP value for each individual condition as the contribution degree of each individual condition to the predicted value. However, the SHAP value is calculated based on a reference value determined by a training data set used for generating the machine learning model. In other words, the SHAP value represents the contribution degree to the change in predicted value from the above reference value. Therefore, it is difficult to interpret the SHAP value as the contribution degree of the individual condition to the change in predicted value when the process condition is changed from any given condition.

SHAP is a technique in which the algorithm for calculating the Shapley value of cooperative game theory is applied to machine learning. The Shapley value has properties such as total group rationality and additivity. Total group rationality is the property that the sum of Shapley values of respective players is equal to the reward obtained by the affiliation of all players. Additivity is the property that the sum of Shapley values of respective players calculated for each of the two rewards is equal to the sum of Shapley values of respective players calculated for the sum of the two rewards.

When players are read as explanatory variables and rewards are read as predicted values, the SHAP value obtained by SHAP has properties of total group rationality and additivity as in the Shapley value. An analysis device 1 according to the embodiment is configured to be able to calculate, for each individual condition, the contribution degree to the change in predicted value when the process condition is changed, according to an algorithm that uses the fact that the SHAP value has total group rationality and additivity.

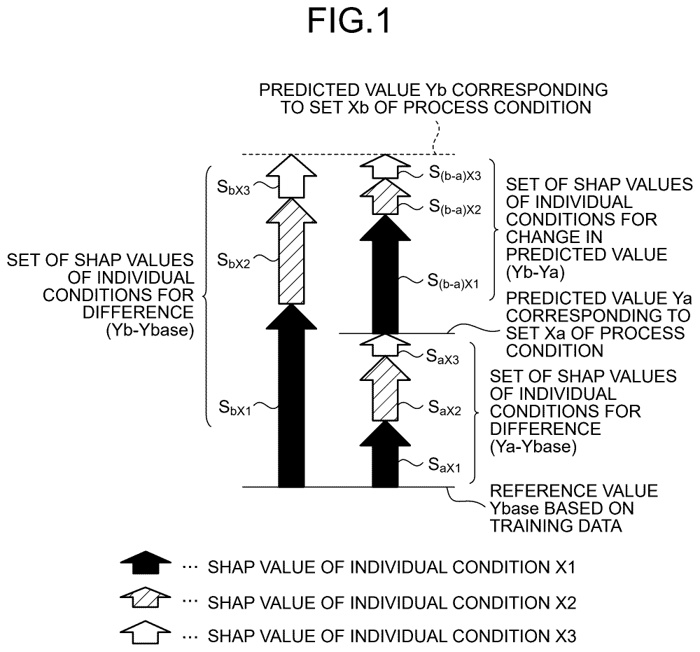

FIG. 1 is a schematic diagram illustrating the algorithm for calculating the contribution degree of each individual condition according to the embodiment.

The analysis device 1 can receive two sets of values for the process condition. When the engineer wants to identify the contribution degree of each individual condition to the change in predicted value when the process condition is changed from the POR condition to the candidate condition, it is possible to input the POR condition as one of the two sets and the candidate condition as the other of the two sets to the analysis device 1.

One of the two sets of process conditions input to the analysis device 1 is denoted as a set Xa and the other as a set Xb. The set Xa is, for example, the POR condition, and the set Xb is, for example, the candidate condition. Examples of two sets of process conditions to be input to the analysis device 1 are not limited to this way.

Each set of process conditions includes two or more individual conditions. According to the example illustrated in FIG. 1, the process condition includes an individual condition X1, an individual condition X2, and an individual condition X3.

The analysis device 1 calculate, by using the prediction model, a predicted value Ya corresponding to the set Xa and a predicted value Yb corresponding to the set Xb.

The analysis device 1 then calculates the SHAP value of each individual condition for the predicted value Yb based on a certain reference value Ybase by using the SHAP algorithm. The SHAP value of each individual condition for the predicted value Yb based on the reference value Ybase represents the contribution degree of each individual condition to the change in the predicted value Yb from the reference value Ybase, or the difference (Yb−Ybase).

S_{bX1} is the SHAP value of the individual condition X1 for the difference (Yb−Ybase), S_{bX2} is the SHAP value of the individual condition X2 for the difference (Yb−Ybase), and S_{bX3} is the SHAP value of the individual condition X3 for the difference (Yb−Ybase). Since each SHAP value has total group rationality, the sum of SHAP value S_{bX1}, the SHAP value S_{bX2}, and the SHAP value S_{bX3} is equal to the difference (Yb−Ybase).

The reference value Ybase is, for example, the average value of the predicted values obtained when each process condition in the training data used for generating the prediction model is input to the prediction model. The reference value Ybase is determined by the SHAP algorithm based on the training data.

By using the SHAP algorithm, the analysis device 1 calculates the SHAP value of each individual condition for the predicted value Ya based on the reference value Ybase. The SHAP value of each individual condition for the predicted value Yb based on the reference value Ybase represents the contribution degree of each individual condition to the change in the predicted value Ya from the reference value Ybase, or the difference (Ya−Ybase).

S_{aX1} is the SHAP value of the individual condition X1 for the difference (Ya−Ybase), S_{aX2} is the SHAP value of the individual condition X2 for the difference (Ya−Ybase), and S_{aX3} is the SHAP value of the individual condition X3 for the difference (Ya−Ybase). Since each SHAP value has total group rationality, the sum of the SHAP value S_{aX1}, the SHAP value S_{aX2}, and the SHAP value S_{aX3} is equal to the difference (Ya−Ybase).

The analysis device 1 obtains the SHAP values S_{(b-a)X1}, S_{(b-a)X2}, and S_{(b-a)X3} of each individual condition for the change in predicted value (Yb−Ya) using the fact that the SHAP value has additivity. Specifically, the analysis device 1 obtains the SHAP values S_{(b-a)X1}, S_{(b-a)X2}, and S_{(b-a)X3} of each individual condition for the change in predicted value (Yb−Ya) by subtracting, for each individual condition, the SHAP values S_{aX1}, S_{aX2}, and S_{aX3} for the difference (Ya−Ybase) from the SHAP values S_{bX1}, S_{bX2}, and S_{bX3} for the difference (Yb−Ybase).

The SHAP value S_{(b-a)X1} is obtained by subtracting the SHAP value S_{aX1} from the SHAP value S_{bX1} and represents the contribution degree of the individual condition X1 to the change in predicted value (Yb−Ya). The SHAP value S_{(b-a)X2} is obtained by subtracting the SHAP value S_{aX2} from the SHAP value S_{bX2} and represents the contribution degree of the individual condition X2 to the change in predicted value (Yb−Ya). The SHAP value S_{(b-a)X3} is obtained by subtracting the SHAP value S_{aX3} from the SHAP value S_{bX3} and represents the contribution degree of the individual condition X3 to the change in predicted value (Yb−Ya).

Thus, the analysis device 1 calculates, for each individual condition, the contribution degree to the change in predicted value (Yb−Ya) when the process condition is changed from the set Xa to the set Xb.

The analysis device 1, the analysis method, and the analysis program according to the embodiment are described in detail below. The invention is not limited by the embodiment.

### Embodiment

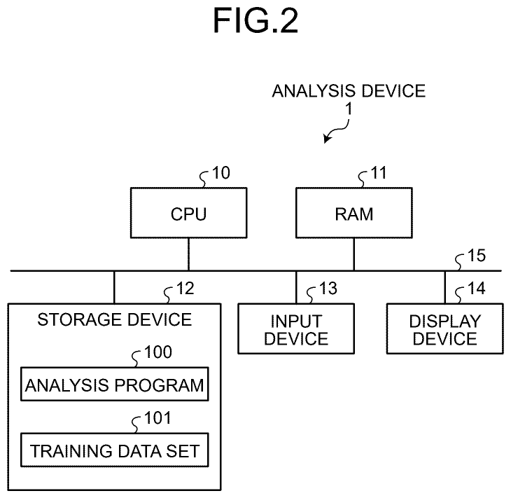

FIG. 2 is a schematic diagram illustrating an example of the hardware configuration of the analysis device 1 according to the embodiment.

The analysis device 1 has the same configuration as an ordinary computer capable of executing computer programs. In the example illustrated in FIG. 2, the analysis device 1 includes a central processing unit (CPU) 10, a random access memory (RAM) 11, a storage device 12, an input device 13, and a display device 14. The CPU 10, the RAM 11, the storage device 12, the input device 13, and the display device 14 are electrically connected to each other via a bus 15.

Input device 13 is a human machine interface (HMI) for information input. The input device 13 includes, for example, a pointing device, a keyboard, or a combination of these. The information input by the operator of the analysis device 1 by operating the input device 13 is transmitted to the CPU 10.

The display device 14 is an HMI that can output information as an image. The display device 14 includes an image display device such as, for example, a liquid crystal display, an electro-luminescence (EL) display, or a plasma display.

The CPU 10 is a processor that executes computer programs.

The RAM 11 is a volatile memory that runs faster than the storage device 12. The RAM 11 provides the CPU 10 with an area as a cache or buffer.

The storage device 12 is a memory capable of storing information, such as data or computer programs in nonvolatile manner. The storage device 12 can include, for example, a hard disk drive (HDD), solid state drive (SSD), or a combination thereof.

The storage device 12 may be installed outside the analysis device 1, and the analysis device 1 and the storage device 12 may be connected via a network or the like. The storage device 12 may be a removable device, such as a Universal Serial Bus (USB) memory, an SD (Secure Digital) card, or an external HDD.

In the embodiment, an analysis program 100 that is a computer program (or programed instructions) is stored in the storage device 12. The CPU 10 loads the analysis program 100 from the storage device 12 into the RAM 11 and executes the analysis program 100 loaded into the RAM 11. The CPU 10 then achieves an operation as the analysis device 1 based on the analysis program 100 loaded into the RAM 11.

The storage device 12 stores a training data set 101. The training data set 101 contains a lot of pairs of the process condition and the process result. The process condition includes, as a plurality of the individual conditions, process parameters of the semiconductor manufacturing device (hereinafter referred to as “process parameters”), the shape of the pattern to be processed (hereinafter referred to as “profile data”), and the like. For example, the semiconductor manufacturing device can include a plasma processing device used for etching and other applications. For the plasma processing device, a gas flow rate, a processing time, a voltage value, and the like can be provided as process parameters. For example, the profile data can include a design dimension of the pattern. The process result includes, for example, a dimensions of the pattern obtained by processing, a property obtained by the process, a processing rate, a physical property, and the like. The process result may include the result related to the plurality of parameters or may include the result related to only one parameter.

In one example, the engineer collects the process result for each process condition by actually processing the semiconductor device while changing the process condition in various ways. The engineer stores pairs of respective process results and the process condition collected in a storage device. The group of pairs of the process condition and the process result accumulated is then stored in the storage device 12 as the training data set 101. The method of generating the training data set 101 is not limited to this way.

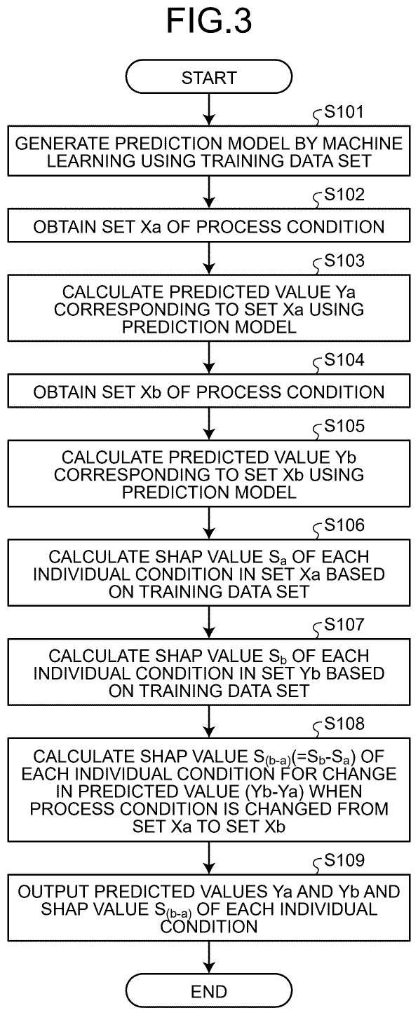

Referring to FIGS. 3 to 6, now describe the details of the operation performed by the analysis device 1 according to the embodiment.

FIG. 3 is a flowchart illustrating an example of the operation of the analysis device 1 according to the embodiment. The CPU 10 executes the series of operations illustrated in this figure according to the analysis program 100. In the description of the example illustrated in this figure, the analysis program 100 is described as the operating entity.

First, the analysis program 100 generates a prediction model by machine learning using the training data set 101 (S101). Various machine learning models can be applied as the prediction model.

In one example, the prediction model can be configured by a neural network model with multiple layers, including an input layer and an output layer. Each of the multiple layers has one or more nodes. Each node is correlated with an activation function and a weight determined by machine learning. The input layer is configured to receive a process condition, and the output layer is configured to output a predicted value of the process result. When the process condition is input to the input layer, the processor (for example, the CPU 10) performs calculation using the activation function and the weight at each node and outputs the predicted value from the output layer.

In another example, the prediction model may be configured by a Gaussian process regression model, a regression model (for example, a linear regression, a support vector regression, a Gaussian process regression, etc.), or a tree system model (for example, a decision tree, a random forest, etc.). Any machine learning model can be applied as a prediction model, as long as the model returns the predicted value according to the input.

The operator of the analysis device 1 can input two sets Xa and Xb of the process condition into the analysis device 1 by operating, for example, the input device 13. The method of inputting the sets Xa and Xb is not limited to this way.

Upon obtaining the set Xa of the process condition (S102), the analysis program 100 calculates, by using a prediction model, the predicted value Ya corresponding to the set Xa (S103). The analysis program 100 inputs the set Xa to the input layer of the prediction model and obtains the predicted value Ya output from the output layer of the prediction model.

Upon obtaining the set Xb of the process condition (S104), the analysis program 100 calculates, by using a prediction model, the predicted value Yb corresponding to the set Xb (S105). The analysis program 100 inputs the set Xb to the input layer of the prediction model and obtains the predicted value Yb output from the output layer of the prediction model.

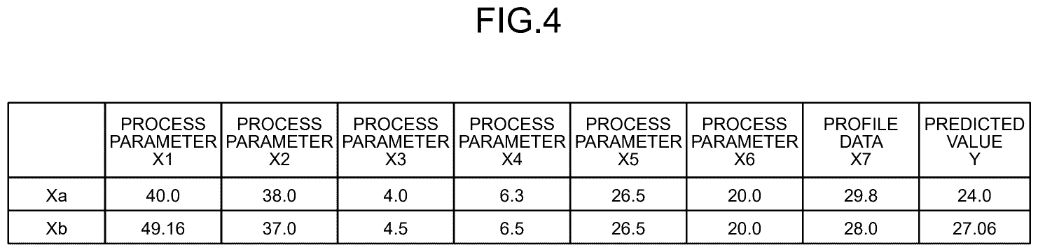

FIG. 4 illustrates an example of a pair of the process condition and the predicted value obtained by processing in S102 to S105 illustrated in FIG. 3. In the example illustrated in this figure, the set of process condition includes a total of seven individual conditions: a process parameter X1, a process parameter X2, a process parameter X3, a process parameter X4, a process parameter X5, a process parameter X6, and a profile data X7. Then, according to the prediction model, the predicted value Y for the parameter of one process result is output. The number of parameters of the predicted value output by the prediction model is not limited to one. The number of parameters of the predicted value output by the prediction model may be two or more. In FIG. 4, the predicted value Y is, for example, the predicted value of a dimension in the process result.

According to the example illustrated in FIG. 4, when the set Xa is input to the prediction model, “24.0” is obtained as the predicted value Y corresponding to the set Xa. When the set Xb is input to the prediction model, “27.06” is obtained as the predicted value Y corresponding to the set Xb.

The description is returned to FIG. 3. The analysis program 100 calculates the SHAP value of each individual condition in the set Xa based on the training data set 101 (S106). The analysis program 100 calculates the SHAP value using the SHAP algorithm. The SHAP value obtained by the process of S106 is denoted as a SHAP value Sₐ. According to the example illustrated in FIG. 1, each of the SHAP values S_{aX1}, S_{aX2}, and S_{aX3} is calculated as the SHAP value Sₐ in S106.

The analysis program 100 calculates the SHAP value of each individual condition in the set Xb based on the training data set 101 (S107). The analysis program 100 calculates the SHAP value using the SHAP algorithm. The SHAP value obtained by the process of S107 is denoted as a SHAP value S_{b}. According to the example illustrated in FIG. 1, each of the SHAP values S_{bX1}, S_{bX2}, and S_{bX3} is calculated as the SHAP value S_{b} in S107.

Each of the SHAP values obtained by S106 and S107 represent the contribution degree to the change in predicted value from the reference value Ybase. The reference value Ybase is determined based on the training data set 101.

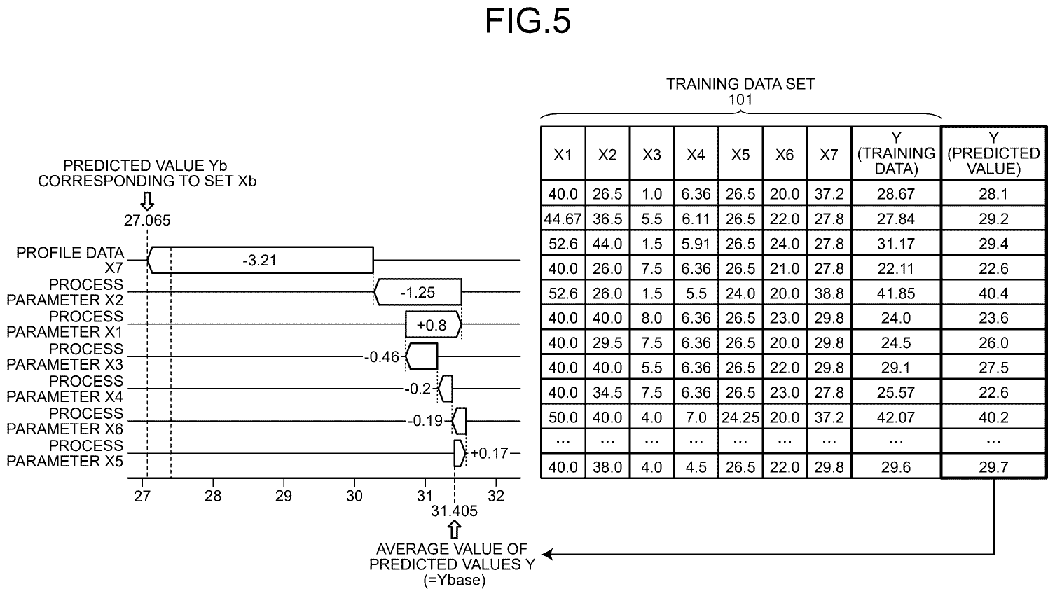

FIG. 5 illustrates the reference value Ybase determined by the training data set 101 according to the embodiment. This figure illustrates the SHAP values of each individual condition for the predicted value Yb, along with the reference value Ybase.

As illustrated in FIG. 5, the training data set 101 includes plural process condition sets each of which includes X1 to X7 individual conditions, and process results Y corresponding to the respective process condition sets. The SHAP algorithm obtains a group of predicted values Y by inputting respective sets of the process condition contained in the training data set 101 into the prediction model. The SHAP algorithm then calculates the SHAP value of each individual condition, using the average value of the group of predicted values Y as the reference value Ybase.

In the example illustrated in FIG. 5, “31.405” is obtained as the average value of the group of predicted values Y, and thus “31.405” is used as the reference value Ybase. As also illustrated in FIG. 4, the predicted value Yb obtained by inputting the set Xb to the prediction model is “27.065”. The SHAP algorithm calculates the SHAP value for each of the individual conditions X1 to X7 by allocating the difference obtained by subtracting “31.405” from “27.065” to the individual conditions X1 through X7.

Among the individual conditions X1 to X7 of the set Xb, the SHAP value of the process parameter X1 is “+0.8”, the SHAP value of the process parameter X2 is “−1.25”, the SHAP value of the process parameter X3 is “−0.46”, the SHAP value of the process parameter X4 is “−0.2”, the SHAP value of the process parameter X5 is “+0.17”, the SHAP value of the process parameter X6 is “−0.19”, and the SHAP value of the profile data X7 is “−3.21”.

The SHAP algorithm calculates the SHAP value of each individual condition based on the training data set 101.

Again, description is returned to FIG. 3. The analysis program 100 calculates the SHAP value S_{(b-a)} of each individual condition for the change in predicted value (Yb−Ya) when the process condition is changed from the set Xa to the set Xb (S108). The analysis program 100 obtains the SHAP value S_{(b-a)} of each individual condition by subtracting, for each individual condition, the SHAP value Sₐ from the SHAP value S_{b}. According to the example illustrated in FIG. 1, each of the SHAP values S_{(b-a)X1}, S_{(b-a)X2}, and S_{(b-a)X3} is calculated as the SHAP value S_{(b-a)}.

The analysis program 100 outputs the predicted values Ya and Yb, and the SHAP value S_{(b-a)} of each individual condition (S109). In S109, the analysis program 100 displays the predicted values Ya and Yb, and the SHAP value S_{(b-a)} of each individual condition on the display device 14, for example. The series of operations of the analysis device 1 is then completed.

The order of execution of the processes S101 to S107 can be changed in various ways. For example, the processes S104 and S105 may be performed before the processes S102 and S103. The process of S107 may be performed before the process of S106.

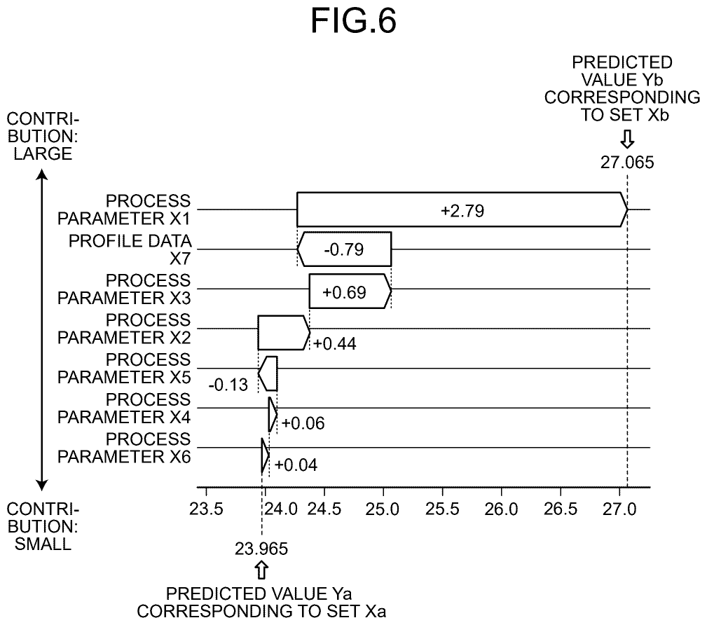

FIG. 6 illustrates an example of how the SHAP value S_{(b-a)} of each individual condition is displayed according to the embodiment.

According to the display example illustrated in FIG. 6, the predicted value Ya is “23.965” and the predicted value Yb is “27.065”.

The SHAP values of respective individual conditions to the change from the predicted value Ya to the predicted value Yb are as follows. The SHAP value of the process parameter X1 is “+2.79”, the SHAP value of the process parameter X2 is “+0.44”, the SHAP value of the process parameter X3 is “+0.69”, the SHAP value of the process parameter X4 is “+0.66”, the SHAP value of the process parameter X5 is “−0.13”, the SHAP value of the process parameter X6 is “+0.04”, and the SHAP value of the profile data X7 is “+2.79”.

This display example can find the following results.
(1) The predicted value change from Ya to Yb by changing the process condition from the set Xa to the set Xb.
(2) The contribution degrees of respective individual conditions to the change in predicted value from Ya to Yb is largest in X1 and decrease in the order of X1, X7, X3, X2, X5, X4, and X6.
(3) Changes in X1, X3, X2, X4, and X6 bring an increase in predicted value, and changes in X7 and X5 bring a decrease in predicted value.

The method of outputting the predicted values Ya and Yb, and the SHAP value S_{(b-a)} of each individual condition is not limited to the method of displaying them on the display device 14. The analysis program 100 may output the information to the storage device 12 or to another computer over a network.

The information output by the analysis program 100 is not limited to the predicted values Ya and Yb and the SHAP value S_{(b-a)} of each individual condition. The analysis program 100 can output any information in addition to the information. The analysis program 100 does not necessarily have to output the predicted values Ya and Yb.

In the examples described above, the SHAP value is used as numerical information to represent the contribution degree. The contribution degree is not limited to the SHAP value. Any numerical information with total group rationality and additivity may be used as numerical information representing the contribution degree.

The analysis device 1 calculates the SHAP value of each of all individual conditions constituting the process condition. The analysis device 1 may be configured to calculate the SHAP values of some of the individual conditions constituting the process condition. The analysis device 1 calculates the SHAP value of at least one of the individual conditions constituting the process condition.

In the process of S108 illustrated in FIG. 3, the SHAP value S_{(b-a)} of each individual condition for the change in predicted value (Yb−Ya) when the process condition is changed from the set Xa to the set Xb is calculated. In S108, the analysis program 100 may be configured to calculate the SHAP value S_{(a-b)} of each individual condition for a change in predicted value (Ya−Yb) when the process condition is changed from the set Xb to the set Xa. In such a case, in S108, the analysis program 100 obtains the SHAP value S_{(a-b)} of each individual condition by subtracting, for each individual condition, the SHAP value S_{b} from the SHAP value Sₐ. In other words, the analysis program 100 may be configured to obtain the SHAP value of each individual condition for a change in predicted value by calculating the difference between the SHAP value Sₐ and SHAP value S_{b} of each individual condition.

As described above, according to the embodiment, the CPU 10 calculates the contribution degree of at least one individual condition (denoted as a first individual condition) for the set Xa, which is a set of values of the individual conditions, based on the training data set 101. The CPU 10 calculates the contribution degree of at least the first individual condition for the set Xb, which is a set of values of the individual conditions and differs from the set Xa, based on the training data set 101. The CPU 10 obtains the contribution degree of at least the first individual condition to the change in predicted value due to a change in the process condition from the set Xa to the set Xb by subtracting the contribution degree related to the set Xa from the contribution degree related to the set Xb for at least the first individual condition. The CPU 10 then outputs the contribution degree of at least the first individual condition to a change in the obtained predicted value.

The operator of the analysis device 1 can obtain the contribution degree of the individual condition to the change in predicted value when the process condition is changed from a given condition. Therefore, the analysis device 1 according to the embodiment is highly convenient for the engineer.

According to the embodiment, the CPU 10 calculates, by using a prediction model, the predicted value Ya corresponding to the set Xa and the predicted value Yb corresponding to the set Xb and outputs the predicted values Ya and Yb.

The engineer is able to know the change in predicted value when changing the process condition from the set Xa to the set Xb. Therefore, the analysis device 1 according to the embodiment is highly convenient for the engineer.

According to the embodiment, the CPU 10 can output the contribution degree to the change in predicted value for each of the two or more individual conditions. The CPU 10 can operate as follows. The CPU 10 calculates, based on the training data set 101, the contribution degree of a second individual condition, which is different from the first individual condition, for the set Xa. The CPU 10 calculates the contribution degree of the second individual condition for the set Xb. The CPU 10 obtains the contribution degree of the second individual condition to the change in predicted value due to a change in the process condition from the set Xa to the set Xb by subtracting the contribution degree related to the set Xa from the contribution degree related to the set Xb for the second individual condition. The CPU 10 then outputs the contribution degree of the second individual condition to a change in the obtained predicted value.

According to the embodiment, the prediction model that receives the process condition as a plurality of explanatory variables and outputs the predicted value of the process result as a predicted value is used. In other words, the embodiment described an example where machine learning is provided in process development. The technology according to the embodiment is applicable to any field, not just process development.

In other words, in the analysis device according to the embodiment, the processor uses a prediction model that is configured to receive multiple explanatory variables and output the predicted value corresponding to the multiple explanatory variables. The processor calculates the first contribution degree, which is a contribution degree of the first explanatory variable of the explanatory variables, for the first set being a set of values of the multiple explanatory variables, based on the training data set used for generating the prediction model. The processor calculates the second contribution degree, which is a contribution degree of the first explanatory variable, for the second set being a set of values of the multiple explanatory variables, the second set being different from the first set, based on the training data set. The processor obtains the third contribution degree by subtracting the first contribution degree from the second contribution degree and outputs the third contribution degree.

Therefore, the operator is able to know the change in predicted value when changing the set of values of the explanatory variables. Thus, the analysis device according to the embodiment is highly convenient for the operator.

The storage device 12 stores, in advance, the analysis program 100 to be executed by the analysis device 1 according to the embodiment. The storage device 12 is an example of a non-transient tangible computer readable storage medium. The analysis program 100 may be configured to be recorded in a non-transitory, tangible computer-readable storage medium such as a compact disc (CD)-read only memory (ROM), a flexible disk (FD), a CD-R (Recordable), a digital versatile disk (DVD), a universal serial bus (USB) memory, and a secure digital (SD) card, with a file in an installable or executable format.

Moreover, the analysis program 100 may be configured to be stored on a computer connected to a network, such as the Internet, and downloaded via the network. The analysis program 100 may be configured to be provided or distributed via a network such as the Internet.

In the embodiment, the series of operations illustrated in FIG. 3 is implemented by the CPU 10 as the processor that is configured to execute the analysis program 100. Some of or all the series of operations illustrated in FIG. 3 may be implemented by a logic circuit. Some of or all the series of operations illustrated in FIG. 3 may be implemented by an analog circuit. Some of or all the series of operations illustrated in FIG. 3 may be implemented by a field-programmable gate array (FPGA), an application specific integrated circuit (ASIC), or the like.

In the embodiment, the storage device 12 stores the training data set 101 in advance. The training data set 101 may be stored on an external device. In this case, the analysis program 100 may be configured to obtain the training data set 101 from the external device.

While certain embodiments have been described, these embodiments have been presented by way of example only, and are not intended to limit the scope of the inventions. Indeed, the novel embodiments described herein may be embodied in a variety of other forms; moreover, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An analysis device comprising a processor configured to:
calculate a first contribution degree being a contribution degree of a first explanatory variable out of multiple explanatory variables for a first set being a set of values of the multiple explanatory variables, the first contribution degree being calculated based on a training data set used for generating a prediction model to which the multiple explanatory variables are input and from which a predicted value corresponding to the multiple explanatory variables is output;
calculate, based on the training data set, a second contribution degree being a contribution degree of the first explanatory variable for a second set, the second set being different from the first set and being a set of values of the multiple explanatory variables;
obtain a third contribution degree by calculating a difference between the first contribution degree and the second contribution degree; and
output the third contribution degree.

2. The analysis device according to claim 1, wherein the processor is further configured to:
calculate, by using the prediction model, a first predicted value corresponding to the first set and a second predicted value corresponding to the second set; and
output the first predicted value and the second predicted value.

3. The analysis device according to claim 1, wherein
the multiple explanatory variables including a second explanatory variable different from the first explanatory variable, and
the processor is further configured to:
calculate, based on the training data set, a fourth contribution degree being a contribution degree of the second explanatory variable for the first set;
calculate, based on the training data set, a fifth contribution degree being a contribution degree of the second explanatory variable for the second set; and
obtain a sixth contribution degree by calculating a difference between the fourth contribution degree and the fifth contribution degree.

4. The analysis device according to claim 1, wherein
the multiple explanatory variables are each a process condition for manufacturing a semiconductor device, and
the predicted value output by the prediction model is a predicted value of a process result.

5. The analysis device according to claim 2, wherein
the multiple explanatory variables are each a process condition for manufacturing a semiconductor device, and
the predicted value output by the prediction model is a predicted value of a process result.

6. The analysis device according to claim 3, wherein
the multiple explanatory variables are each a process condition for manufacturing a semiconductor device, and
the predicted value output by the prediction model is a predicted value of a process result.

7. An analysis method comprising:
calculating a first contribution degree being a contribution degree of a first explanatory variable out of multiple explanatory variables for a first set being a set of values of the multiple explanatory variables, the first contribution degree being calculated based on a training data set used for generating a prediction model to which the multiple explanatory variables are input and from which a predicted value corresponding to the multiple explanatory variables is output;
calculating, based on the training data set, a second contribution degree being a contribution degree of the first explanatory variable for a second set, the second set being different from the first set and being a set of values of the multiple explanatory variables;
obtaining a third contribution degree by calculating a difference between the first contribution degree and the second contribution degree; and
outputting the third contribution degree.

8. The analysis method according to claim 7, further comprising:
calculating, by using the prediction model, a first predicted value corresponding to the first set and a second predicted value corresponding to the second set; and
outputting the first predicted value and the second predicted value.

9. The analysis method according to claim 7, wherein
the multiple explanatory variables including a second explanatory variable different from the first explanatory variable, and
the analysis method further comprises:
calculating, based on the training data set, a fourth contribution degree being a contribution degree of the second explanatory variable for the first set;
calculating, based on the training data set, a fifth contribution degree being a contribution degree of the second explanatory variable for the second set; and
obtaining a sixth contribution degree by calculating a difference between the fourth contribution degree and the fifth contribution degree.

10. The analysis method according to claim 7, wherein
the multiple explanatory variables are each a process condition for manufacturing a semiconductor device, and
the predicted value output by the prediction model is a predicted value of a process result.

11. The analysis method according to claim 8, wherein
the multiple explanatory variables are each a process condition for manufacturing a semiconductor device, and
the predicted value output by the prediction model is a predicted value of a process result.

12. The analysis method according to claim 9, wherein
the multiple explanatory variables are each a process condition for manufacturing a semiconductor device, and
the predicted value output by the prediction model is a predicted value of a process result.

13. A non-transitory computer-readable recording medium on which programmed instructions are recorded, the instructions causing a computer to execute processing, the processing comprising:
calculating a first contribution degree being a contribution degree of a first explanatory variable out of multiple explanatory variables for a first set being a set of values of the multiple explanatory variables, the first contribution degree being calculated based on a training data set used for generating a prediction model to which the multiple explanatory variables are input and from which a predicted value corresponding to the multiple explanatory variables is output;
calculating, based on the training data set, a second contribution degree being a contribution degree of the first explanatory variable for a second set, the second set being different from the first set and being a set of values of the multiple explanatory variables;
obtaining a third contribution degree by calculating a difference between the first contribution degree and the second contribution degree; and
outputting the third contribution degree.

14. The non-transitory computer-readable recording medium according to claim 13, wherein the processing further comprises:
calculating, by using the prediction model, a first predicted value corresponding to the first set and a second predicted value corresponding to the second set; and
outputting the first predicted value and the second predicted value.

15. The non-transitory computer-readable recording medium according to claim 13, wherein
the multiple explanatory variables including a second explanatory variable different from the first explanatory variable, and
the processing further comprises:
calculating, based on the training data set, a fourth contribution degree being a contribution degree of the second explanatory variable for the first set;
calculating, based on the training data set, a fifth contribution degree being a contribution degree of the second explanatory variable for the second set; and
obtaining a sixth contribution degree by calculating a difference between the fourth contribution degree and the fifth contribution degree.

16. The non-transitory computer-readable recording medium according to claim 13, wherein
the multiple explanatory variables are each a process condition for manufacturing a semiconductor device, and
the predicted value output by the prediction model is a predicted value of a process result.

17. The non-transitory computer-readable recording medium according to claim 14, wherein
the multiple explanatory variables are each a process condition for manufacturing a semiconductor device, and
the predicted value output by the prediction model is a predicted value of a process result.

18. The non-transitory computer-readable recording medium according to claim 15, wherein
the multiple explanatory variables are each a process condition for manufacturing a semiconductor device, and
the predicted value output by the prediction model is a predicted value of a process result.
